(19) United States
(12) Patent Application Publication
(10) Pub. No.: US 2023/0320314 A1
(43) Pub. Date: Oct. 12, 2023

(54) PET TOILET

(71) Applicant: JIANGSU ZHONGHENG PET ARTICLES JOINT-STOCK CO., LTD., Jiangsu (CN)

(72) Inventor: Bin QIU, Jiangsu (CN)

(73) Assignee: JIANGSU ZHONGHENG PET ARTICLES JOINT-STOCK CO., LTD., Jiangsu (CN)

(21) Appl. No.: 17/829,380

(22) Filed: Jun. 1, 2022

(30) Foreign Application Priority Data
Apr. 11, 2022 (CN) 202210372970.9

(51) Int. Cl. A01K 1/01

(52) U.S. Cl. CPC A01K 1/011

(57) ABSTRACT

A pet toilet, including a casing and a clearing rake, wherein the casing is provided therein with a garbage box and a litter box which are spaced apart, a chain transmission device is mounted on the casing, and the clearing rake is connected to the chain transmission device to allow the clearing rake to reciprocate between the garbage box and the litter box to clean up wastes in the litter box. The garbage box is spaced apart from the litter box by a partition plate with a slope, and the chain transmission device at least includes a lifting section for reciprocally moving the clearing rake over the partition plate.

### CROSS-REFERENCE TO RELATED APPLICATION

This application claims the priority benefit of China application serial no. 202210372970.9, filed on Apr. 11, 2022. The entirety of the above-mentioned patent application is hereby incorporated by reference herein and made a part of this specification.

### TECHNICAL FIELD

The present invention relates to the field of pet waste collection and storage, and in particular, to a pet toilet.

### BACKGROUND

A pet toilet is a household device for collecting and storing pet excrement. Usually, the pet toilet is provided with litter for a pet to defecate. After the pet defecates on the litter, a host cleans up the excrement on the litter.

However, for an existing pet toilet used in life, the excrement on the litter is mostly cleaned up by a manual operation, which wastes time and labor and is insanitary, thereby bringing much inconvenience to a user. A clearing rake has a height unable to be changed in a garbage box, resulting in a low utilization rate of the garbage box. In a prior art, some clearing rakes are rotatable, but such a design is complex, and the clearing rake has a poor stopping effect during clean-up of the excrement on the litter, or a rotational joint of the clearing rake inevitably has a poor stopping effect due to a defect or service life after a period of use, possibly resulting in incomplete clean-up of the excrement on the litter.

### SUMMARY

In view of defects in a prior art, the present invention provides a pet toilet, in which a clearing rake is reciprocated between a garbage box and a litter box by a chain transmission device, so as to clean up wastes in the litter box; the chain transmission device is provided with a lifting section, such that the clearing rake may be moved over a partition plate.

The above-mentioned technical object is achieved by the following technical means in the present invention.

A pet toilet, includes: a casing and a clearing rake, wherein the casing is provided therein with a garbage box and a litter box which are spaced apart, a chain transmission device is mounted on the casing, the clearing rake is connected to the chain transmission device to allow the clearing rake to reciprocate between the garbage box and the litter box to clean up wastes in the litter box.

Further, the garbage box is spaced apart from the litter box by a partition plate with a slope, and the chain transmission device at least includes a lifting section for reciprocally moving the clearing rake over the partition plate.

Further, a drop exists on a conveying path of the chain transmission device and is configured for keeping a distance between a bottom of the clearing rake entering the garbage box and a bottom of the garbage box.

Further, the chain transmission device includes a first linear section, the lifting section, a second linear section, and a connecting section, the first linear section has a less mounting height than the second linear section, the lifting section is provided between one end of the first linear section and one end of the second linear section, and the connecting section is provided between the other end of the first linear section and the other end of the second linear section.

Further, the chain transmission device further includes a plurality of chain wheels, the first linear section, the lifting section, the second linear section, and the connecting section include at least two chain wheels, and one of the chain wheels is connected to a power system.

Further, a fixing part is provided on any link of a chain of the chain transmission device, and the fixing part is connected to the clearing rake.

Further, the clearing rake is inclined relative to a bottom surface of the garbage box and/or the litter box.

Further, the clearing rake is connected to the fixing part by a support shaft, and the support shaft is in direct or indirect contact with a wall surface of the casing and is configured to support the clearing rake.

Further, a rolling body is mounted on the support shaft, and the rolling body is in contact with the wall surface of the casing in a manner of a rolling pair.

Further, the garbage box is provided with an openable garbage box cover.

Further, a disinfection and odor removal apparatus is mounted on the casing and configured to remove odor from an interior of the litter box and disinfect the interior of the litter box, and a sensor is mounted on the casing and configured to identify whether a pet exists in the litter box.

The present invention has the beneficial effects as follows.
1. In the pet toilet according to the present invention, the clearing rake is reciprocated between the garbage box and the litter box by the chain transmission device, such that the wastes in the litter box may be rapidly cleaned up by the clearing rake.
2. In the pet toilet according to the present invention, the chain transmission device is provided with the lifting section, such that the clearing rake is conveniently moved over the partition plate into the garbage box.
3. In the pet toilet according to the present invention, the chain transmission device is provided with the lifting section and the drop, such that the distance is kept between the bottom of the clearing rake entering the garbage box and the bottom of the garbage box, thus greatly increasing a utilization rate of the garbage box, and storing more wastes in the garbage box compared with an apparatus with the bottom of the clearing rake being in contact with the bottom of the garbage box.
4. In the pet toilet according to the present invention, the fixing part is provided on any link of the chain of the chain transmission device and connected to the clearing rake, and although the clearing rake cannot rotate, the clearing rake may be rapidly moved by the chain transmission device after having a reduced weight; and the clearing rake is inclined relative to the bottom surface of the garbage box and/or the litter box and may be always kept inclined relative to the bottom surface in the moving process of the clearing rake.
5. In the pet toilet according to the present invention, the clearing rake is in direct or indirect contact with the wall surface of the casing by the support shaft for supporting the clearing rake, thus guaranteeing stability of the clearing rake in the moving process.

### BRIEF DESCRIPTION OF THE DRAWINGS

In order to more clearly explain the technical solutions of the embodiments of the present invention or the prior art, the drawings to be used in the descriptions of the embodiments or the prior art are briefly introduced as follows. The following drawings illustrate some embodiments of the present invention, and apparently, a person skilled in the art can obtain other drawings from these drawings without any creative effort.

FIG. 1 is a three-dimensional diagram of a pet toilet according to the present invention.

FIG. 2 is a three-dimensional diagram of the pet toilet according to the present invention with a clearing rake entering a garbage box.

In the drawings:

1—litter box; 2—clearing rake; 3—garbage box cover; 4—fixing part; 5—driving wheel; 6—chain; 7—driven wheel; 8—transmission shaft; 9—motor; 10—partition plate; 11—support shaft; 12—ultraviolet emitter; 13—sensor; 14—garbage box.

### DETAILED DESCRIPTION OF THE EMBODIMENTS

The present invention is further described below with reference to the accompanying drawings and embodiments, but the protection scope of the present invention is not limited thereto.

Reference will be made in detail to embodiments of the present invention, and the examples of the embodiments are illustrated in the drawings, wherein the same or similar elements and the elements having same or similar functions are denoted by like reference numerals throughout the descriptions. The embodiments described below with reference to drawings are illustrative, and intended for explaining the present invention. The embodiments shall not be construed to limit the present invention.

In descriptions of the present invention, it should be understood that, directions or positional relationships indicated by terms “center”, “longitudinal”, “transverse”, “length”, “width”, “thickness”, “upper”, “lower”, “axial”, “radial”, “vertical”, “horizontal”, “inner”, “outer”, etc. are based on orientations or positional relationships shown in the accompanying drawings, and they are used only for describing the present invention and for description simplicity, but do not indicate or imply that an indicated device or element must have a specific orientation or be constructed and operated in a specific orientation. Therefore, it cannot be understood as a limitation on the present invention. In addition, the terms such as “first” and “second” are merely used for purposes of description and are not intended to indicate or imply relative importance or to imply the number of indicated technical features. Thus, the feature defined with “first” and “second” may include one or more of this feature explicitly or implicitly. In the description of the present invention, “a plurality of” means two or more, unless otherwise specified.

In the present invention, unless specified or limited otherwise, the terms “mounted”, “connected”, “coupled”, “fixed” and the like are used broadly, and may be, for example, fixed connections, detachable connections, or integral connections; may also be mechanical or electrical connections; may also be direct connections or indirect connections via intervening structures; may also be inner communications of two elements. The above terms can be understood by those skilled in the art according to specific situations.

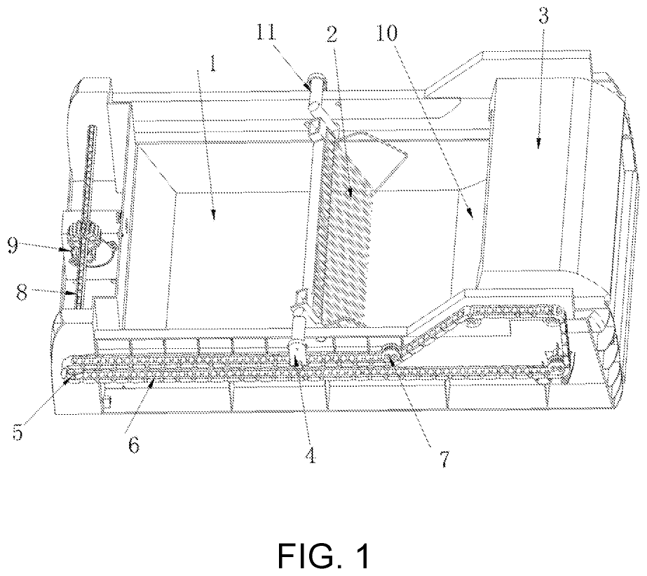

As shown in FIG. 1, a pet toilet according to the present invention includes a casing, a clearing rake 2, and a power system; the power system is located in one end of the casing, the casing is provided therein with a garbage box 14 and a litter box 1 which are spaced apart, and the garbage box 14 is spaced apart from the litter box 1 by a partition plate 10 with a slope. A chain transmission device is mounted on a side surface of the casing, the clearing rake 2 has one end connected to the chain transmission device to allow the clearing rake 2 to reciprocate between the garbage box 14 and the litter box 1 to clean up wastes in the litter box 1.

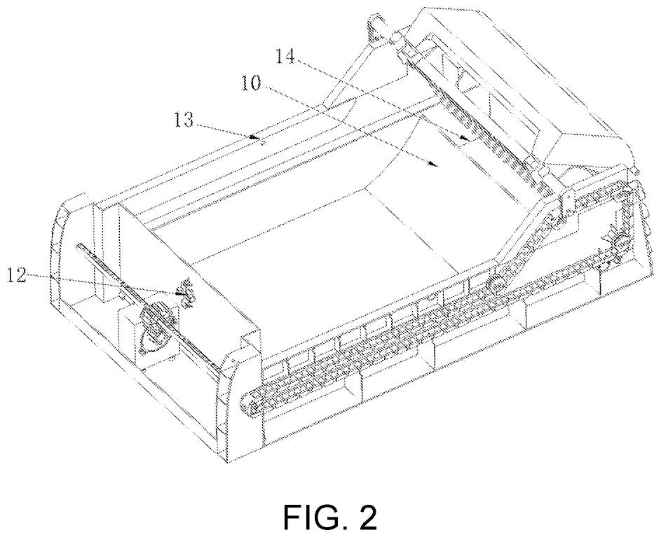

As shown in FIG. 1 and FIG. 2, the chain transmission device at least includes a lifting section for reciprocally moving the clearing rake 2 over the partition plate 10. A height difference exists on a conveying path of the chain transmission device and is configured for keeping a distance between a bottom of the clearing rake 2 entering the garbage box 14 and a bottom of the garbage box 14, thus greatly increasing a utilization rate of the garbage box 14.

As shown in FIG. 1, the chain transmission device includes a first linear section, the lifting section, a second linear section, and a connecting section. The first linear section has a less mounting height than the second linear section, the lifting section is provided between one end of the first linear section and one end of the second linear section, and the connecting section is provided between the other end of the first linear section and the other end of the second linear section. The chain transmission device further includes a driving wheel 5 and a plurality of driven wheels 7, at least 1 driven wheel 7 is provided on each of the first linear section, the lifting section, the second linear section, and the connecting section, the driving wheel 5 is provided on the first linear section, and the driving wheel 5 is connected to the power system. The power system includes a motor 9 and a transmission shaft 8, the motor 9 is located inside one end of the casing, the motor 9 is connected to the transmission shaft 8 directly or through a gear train, and the driving wheel 5 is mounted at one end of the transmission shaft 8.

A fixing part 4 is provided on any link of a chain 6 of the chain transmission device, and the fixing part 4 is connected to the clearing rake 2. The clearing rake 2 is inclined relative to a bottom surface of the garbage box 14 and/or the litter box 1, and although the clearing rake cannot rotate, the clearing rake may be rapidly reciprocated by the chain transmission device after having a reduced weight; and the clearing rake is inclined relative to the bottom surface of the garbage box 14 and/or the litter box and may be always kept inclined relative to the bottom surface in the moving process of the clearing rake, thus guaranteeing complete clean-up of the wastes in the litter box.

The clearing rake 2 is connected to the fixing part 4 by a support shaft 11, and the support shaft 11 is in direct or indirect contact with a wall surface of the casing and is configured to support the clearing rake 2. In order to prevent direct friction between the support shaft 11 and the wall surface of the casing, a rolling body is mounted on the support shaft 11, and the rolling body is in contact with the wall surface of the casing in a manner of a rolling pair. The rolling body is generally a rolling bearing or roller.

In order to ensure that the clearing rake 2 may stably climb in the moving process, the wall surface of the casing is provided with a first linear wall surface, a second linear wall surface, and an inclined wall surface; the first linear wall surface is lower than the second linear wall surface, the first linear wall surface smoothly transitions to the second linear wall surface through the inclined wall surface, the first linear wall surface corresponds to the first linear section, the second linear wall surface corresponds to the second linear section, and the inclined wall surface corresponds to the lifting section, such that the rolling body always is in contact with the first linear wall surface, the inclined wall surface, and the second linear wall surface when the clearing rake 2 successively passes through the first linear section, the lifting section, and the second linear section.

The garbage box 14 is provided with an openable garbage box cover 3. An ultraviolet emitter is mounted on the casing and configured to remove odor from an interior of the litter box 1 and disinfect the interior of the litter box 1, and a sensor is mounted on the casing and configured to identify whether a pet exists in the litter box 1, thus ensuring that no pet exists in the litter box 1 when the clearing rake 2 moves.

In another embodiment, chain transmission devices are mounted on two side surfaces of the casing respectively, the clearing rake 2 has two ends connected to the chain transmission devices on the two sides respectively, to allow the clearing rake 2 to reciprocate between the garbage box 14 and the litter box 1 to clean up wastes in the litter box 1.

It should be understood that although the specification is described in terms of various embodiments, not every embodiment only includes an independent technical solution, and such description of the specification is for clarity only; those skilled in the art should take the specification as a whole, and the technical solutions in various embodiments may also be appropriately combined to form other embodiments that may be understood by those skilled in the art.

The series of detailed descriptions listed above are only specific descriptions for the feasible embodiments of the present invention, and are not intended to limit the protection scope of the present invention, and all equivalent embodiments or modifications made without departing from the technical spirit of the present invention shall be included within the protection scope of the present invention.

What is claimed is:

1. A pet toilet, comprising a casing and a clearing rake, wherein the casing is provided therein with a garbage box and a litter box which are spaced apart, a chain transmission device is mounted on the casing, the clearing rake is connected to the chain transmission device to allow the clearing rake to reciprocate between the garbage box and the litter box (1) to clean up wastes in the litter box.

2. The pet toilet according to claim 1, wherein the garbage box is spaced apart from the litter box by a partition plate with a slope, and the chain transmission device at least comprises a lifting section for reciprocally moving the clearing rake over the partition plate.

3. The pet toilet according to claim 1, wherein a drop exists on a conveying path of the chain transmission device, and the drop is configured for keeping a distance between a bottom of the clearing rake entering the garbage box and a bottom of the garbage box.

4. The pet toilet according to claim 2, wherein the chain transmission device comprises a first linear section, the lifting section, a second linear section, and a connecting section, the first linear section has a less mounting height than the second linear section, the lifting section is provided between a first end of the first linear section and a first end of the second linear section, and the connecting section is provided between a second end of the first linear section and a second end of the second linear section.

5. The pet toilet according to claim 4, wherein the chain transmission device further comprises a plurality of chain wheels, the first linear section, the lifting section, the second linear section, and the connecting section comprise at least two chain wheels, and one of the chain wheels is connected to a power system.

6. The pet toilet according to claim 1, wherein a fixing part is provided on a link of a chain of the chain transmission device, and the fixing part is connected to the clearing rake.

7. The pet toilet according to claim 6, wherein the clearing rake is inclined relative to a bottom surface of the garbage box and/or the litter box.

8. The pet toilet according to claim 6, wherein the clearing rake is connected to the fixing part by a support shaft, and the support shaft is in direct or indirect contact with a wall surface of the casing and is configured to support the clearing rake.

9. The pet toilet according to claim 8, wherein a rolling body is mounted on the support shaft, and the rolling body is in contact with the wall surface of the casing in a manner of a rolling pair.

10. The pet toilet according to claim 1, wherein the garbage box is provided with an openable garbage box cover.

11. The pet toilet according to claim 1, wherein a disinfection and odor removal apparatus is mounted on the casing and configured to remove odor from an interior of the litter box and disinfect the interior of the litter box, and a sensor is mounted on the casing and configured to identify whether a pet exists in the litter box.

12. The pet toilet according to claim 3, wherein the chain transmission device comprises a first linear section, the lifting section, a second linear section, and a connecting section, the first linear section has a less mounting height than the second linear section, the lifting section is provided between a first end of the first linear section and a first end of the second linear section, and the connecting section is provided between a second end of the first linear section and a second end of the second linear section.

13. The pet toilet according to claim 2, wherein a fixing part is provided on a link of a chain of the chain transmission device, and the fixing part is connected to the clearing rake.

14. The pet toilet according to claim 3, wherein a fixing part is provided on a link of a chain of the chain transmission device, and the fixing part is connected to the clearing rake.
